(19) United States
(12) Patent Application Publication
(10) Pub. No.: US 2026/0063799 A1
(43) Pub. Date: Mar. 5, 2026

(54) TIME-OF-FLIGHT DETECTING DEVICE, SYSTEM, AND METHOD

(71) Applicant: Taiwan Semiconductor Manufacturing Company, Ltd., Hsinchu (TW)

(72) Inventors: Shang-Fu Yeh, Hsinchu City (TW); Meng-Hsiu Wu, Hsinchu (TW)

(73) Assignee: Taiwan Semiconductor Manufacturing Company, Ltd., Hsinchu (TW)

(21) Appl. No.: 18/822,441

(22) Filed: Sep. 2, 2024

(51) Int. Cl. G01S 17/10; G01S 7/48; G01S 7/4861; G01S 7/4865; G01S 7/497

(52) U.S. Cl. CPC G01S 17/10; G01S 7/4802; G01S 7/4861; G01S 7/4865; G01S 7/497

(57) ABSTRACT

A time-of-flight (TOF) detecting device is provided herein. The TOF detecting device includes a single-photon avalanche diode (SPAD) sensing circuit and a processing circuit. The SPAD sensing circuit is configured to: receive a reflected light reflected from an object; and output a SPAD output signal based on the reflected light. The processing circuit is coupled to the SPAD sensor and configured to: determine that whether the object is a near target or a far target based on the SPAD output signal; in response to the object is the near target or the far target being determined, adjust a mode of the SPAD sensing circuit; and determine a distance between the object and the TOF detecting device based on the mode.

### BACKGROUND

### Technical Field

The disclosure relates to a time-of-flight (TOF) detecting device; particularly, the disclosure relates to a TOF detecting device, a TOF detecting system, and a TOF detecting method.

### Description of Related Art

Time-of-Flight (TOF) is a method for measuring the distance between a sensor and an object, based on the time difference between the emission of a signal and a return of the signal to the sensor after being reflected by an object. That is, TOF is able to realize depth sensing, which is also known as range sensing. TOF sensors are highly advanced light detection and ranging (LIDAR) devices which replace the standard point by point scanning laser beams with a single light pulse to achieve full spatial awareness. TOF measurement of a ray of light generated by a mono-chromatic or wide-spectral light source can be also used in various applications, such as automotive LIDAR, 3D vision, face recognition, and range-finding. In other words, TOF sensors can be implemented to navigate a self-driving vehicle, track facial or hand movements, and map out a room, etc.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram of a TOF detecting scenario according to an embodiment of the disclosure.

FIG. 2A, FIG. 2B, FIG. 2C are schematic diagrams of TOF detecting scenario according to some embodiments of the disclosure.

FIG. 3 is a schematic diagram of a TOF detecting configuration of a TOF detecting according to an embodiment of the disclosure.

FIG. 4A to FIG. 4D is schematic diagrams of simulation results of dark count ratios of a TOF detecting according to some embodiment of the disclosure.

FIG. 5 is a schematic circuit structure of a TOF detecting device according to an embodiment of the disclosure.

FIG. 6 is a schematic timing chart of a TOF detecting device according to an embodiment of the disclosure.

FIG. 7 is a schematic flowchart of a TOF detecting method according to an embodiment of the disclosure.

FIG. 8A and FIG. 8B are schematic circuit structures of a TOF detecting device to some embodiments of the disclosure.

### DESCRIPTION OF THE EMBODIMENTS

Reference will now be made in detail to the exemplary embodiments of the disclosure, examples of which are illustrated in the accompanying drawings. Whenever possible, the same reference numbers are used in the drawings and the description to refer to the same or like components.

Certain terms are used throughout the specification and appended claims of the disclosure to refer to specific components. Those skilled in the art should understand that electronic device manufacturers may refer to the same components by different names. This article does not intend to distinguish those components with the same function but different names. In the following description and rights request, the words such as “comprise” and “include” are open-ended terms, and should be explained as “including but not limited to . . . ”.

The term “coupling (or connection)” used throughout the whole specification of the present application (including the appended claims) may refer to any direct or indirect connection means. For example, if the text describes that a first device is coupled (or connected) to a second device, it should be interpreted that the first device may be directly connected to the second device, or the first device may be indirectly connected through other devices or certain connection means to be connected to the second device. The terms “first”, “second”, and similar terms mentioned throughout the whole specification of the present application (including the appended claims) are merely used to name discrete elements or to differentiate among different embodiments or ranges. Therefore, the terms should not be regarded as limiting an upper limit or a lower limit of the quantity of the elements and should not be used to limit the arrangement sequence of elements. In addition, wherever possible, elements/components/steps using the same reference numerals in the drawings and the embodiments represent the same or similar parts. Reference may be mutually made to related descriptions of elements/components/steps using the same reference numerals or using the same terms in different embodiments.

It should be noted that in the following embodiments, the technical features of several different embodiments may be replaced, recombined, and mixed without departing from the spirit of the disclosure to complete other embodiments. As long as the features of each embodiment do not violate the spirit of the disclosure or conflict with each other, they may be mixed and used together arbitrarily.

Time-of-Flight (TOF) is a method for measuring the distance between a sensor and an object, based on the time difference between the emission of a signal and a return of the signal to the sensor after being reflected by an object. That is, TOF is able to realize depth sensing, which is also known as range sensing. TOF sensors are highly advanced light detection and ranging (LIDAR) devices which replace the standard point by point scanning laser beams with a single light pulse to achieve full spatial awareness. TOF measurement of a ray of light generated by a mono-chromatic or wide-spectral light source can be also used in various applications, such as automotive LIDAR, 3D vision, face recognition, and range-finding. In other words, TOF sensors can be implemented to navigate a self-driving vehicle, track facial or hand movements, and map out a room, etc.

It is noted that, a TOF sensor may utilize time-correlated single photon counting (TCSPC) methodology to achieve a high precision resolution of depth sensing of the target. A single-photon avalanche diode (SPAD) may be integrated with a pulse laser to achieve depth sensing utilizing the TSCPS methodology. The SPAD is a solid-state photodetector, in which, through an internal photoelectric effect, a photon-generated carrier can trigger a short-duration but relatively large avalanche current. That is, when a photon is received, avalanche current indicating the detection is generated. This avalanche current is created through a mechanism called impact ionization, in which, electrons and/or holes, as carriers, are accelerated to high kinetic energies through a large potential gradient. If the kinetic energy of a received electron, or a hole, is large enough (as a function of the ionization energy of the bulk material), additional carriers (electrons and/or holes) are liberated from the atomic lattice. As a result, the number of carriers increases exponentially from as few as a single carrier to create the avalanche current.

The SPAD is capable of detecting different types of low-intensity ionizing radiation, including: gamma, X-ray, beta, and alpha-particle radiation along with electromagnetic signals in the UV, Visible and IR down to the single photon level. The SPAD is also capable of distinguishing the arrival times of events (photons) at high accuracy with a timing jitter of only a few tens of picoseconds. The SPAD have recently been implemented in LIDAR, TOF 3D Imaging, positron emission tomography (PET) scanning, single-photon experimentation, fluorescence lifetime microscopy and optical communications, particularly quantum key distribution.

It is worth mentioned, while an object is too far away from the SPAD, the accuracy of the depth sensing of the SPAD may decrease due to a background noise (e.g., dark count) caused by the characteristic of the SPAD. This is because that, as a distance between the object and the SPAD become greater and greater, the signal strength of a detected signal (e.g., reflected light) may become less and less. In some circumstances, the signal strength of the detected signal may be even smaller than the signal strength of the background noise. To solve this problem, by increasing the power of the pulse laser, the signal strength of the detected signal may be greater. However, the high pulse laser power may cause serious eye safety issues. Alternatively, coincidence detection technique may be utilized to distinguish the detected signal from the background noise. However, the coincidence detection technique may also make both of the detected signal and the background noise smaller and therefore the number of the detected signal needs to be large enough to detect one detected signal. On the other hand, since the dark count noise is caused by the characteristic of the SPAD, not from the environment, an optical filter cannot mitigate the influence of the background noise. Therefore, how to develop an effective and energy-saving method to perform the depth sensing for an object far away from the SPAD is becoming an issue to work on.

In this disclosure, the depth sensing of the object is performed in two stages, a “far target detection” stage and a “control logic” stage. That is, the object is determined as the near target or the far target. Then, the TOF detecting device is controlled based on the detecting result of the “far target detection” stage. In this manner, the depth sensing is able to be performed accurately no matter the object is close to or far from the TOF detecting device.

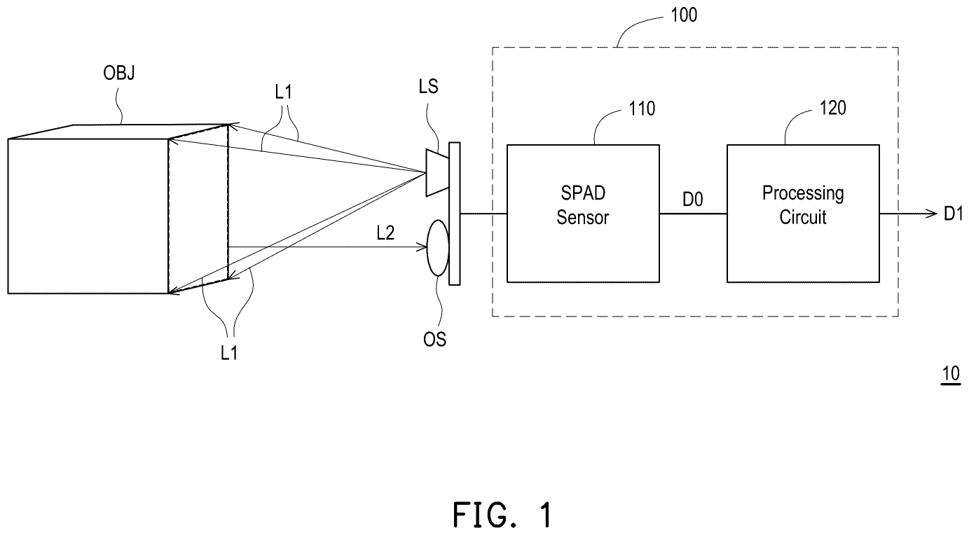

FIG. 1 is a schematic diagram of a TOF detecting scenario according to an embodiment of the disclosure. Referring to FIG. 1, a TOF detecting scenario 10 may include an object OBJ and a TOF detecting system. The TOF detecting system includes a TOF detecting device 100, a light source LS, and an optical system OS.

In one embodiment, the TOF detecting device 100 may include a SPAD sensor 110 and a processing circuit 120. For example, the light source LS may be a pulse layer source and the incident light L1 may be a pulse laser. The optical system may be configured to receive at least one reflected light L2 after the incident light L1 being reflected by the object OBJ and provide the reflected light L2 to the SPAD sensor 110. That is, the SPAD sensor 110 may be configured to receive the reflected light L2 reflected from the object OBJ. It is noted that, a SPAD event may be defined as the SPAD sensor 110 receiving one light. Further, the SPAD sensor 110 may be configured to output an original data DO based on the reflected light L2. The processing circuit 120 may be coupled to the SPAD sensor 110 and configured to receive the original data DO from the SPAD sensor 110. Further, the processing circuit 120 may be configured to process the original data DO to generate distance data D1. Specifically, the processing circuit 120 may be configured to determine whether the object is a “near target” or a “far target” based on the original data DO and perform a corresponding algorithm to generate the distance data D1. The distance data D1 may include distance information of the object OBJ from the TOF detecting device 100. In this manner, the TOF detecting device 100 is able to perform the depth sensing accurately no matter the object OBJ is close to or far from the TOF detecting device 100.

In one embodiment, the light source LS may include a laser light source that emits laser pulses as the incident light L1 to the object OBJ, but the disclosure is not limited to any specific type of light source LS. In one embodiment, the light source LS may be a visible laser source which is visible to the human eyes, so the incident light L1 may be directly observed with the human eyes. In one embodiment, the light source LS may be an infrared (IR) laser source or a near infrared (NIR) laser source which is invisible to the human eyes, so the incident light L1 may not cause damage to the human eyes and the depth sensing and the image sensing may be performed silently. However, this disclosure is not limited thereto.

In one embodiment, the optical system OS may include, for example, a lens, a complementary metal oxide semiconductor (CMOS) camera, a charge coupled device (CCD) camera, or a combination of the elements. Further, the optical system OS may include an IR band-pass filter or a NIR bandpass filter. However, this disclosure is not limited thereto.

In one embodiment, the SPAD sensor 110 may be a Germanium-Silicon SPAD sensor, which is sensitive to IR laser. It is noted that, for most of the time, due to the near absence of IR light in natural environment, adopting infrared light as a light source and utilizing IR-sensitive SPAD sensor 110 may minimize environmental interference in depth sensing (i.e., reject most of the ambient light). However, this disclosure is not limited thereto.

In one embodiment, the processor circuit 120 may be configured to determine whether the object OBJ is a far target or not. Then, the processor circuit 120 may be configured to adjust a mode of the SPAD sensor 110 and process the data outputted from the SPAD sensor 110. In this manner, an effective and energy-saving method to perform the depth sensing for an object OBJ far away from the TOF detecting device 100 may be achieved, which would be further discussed in the following.

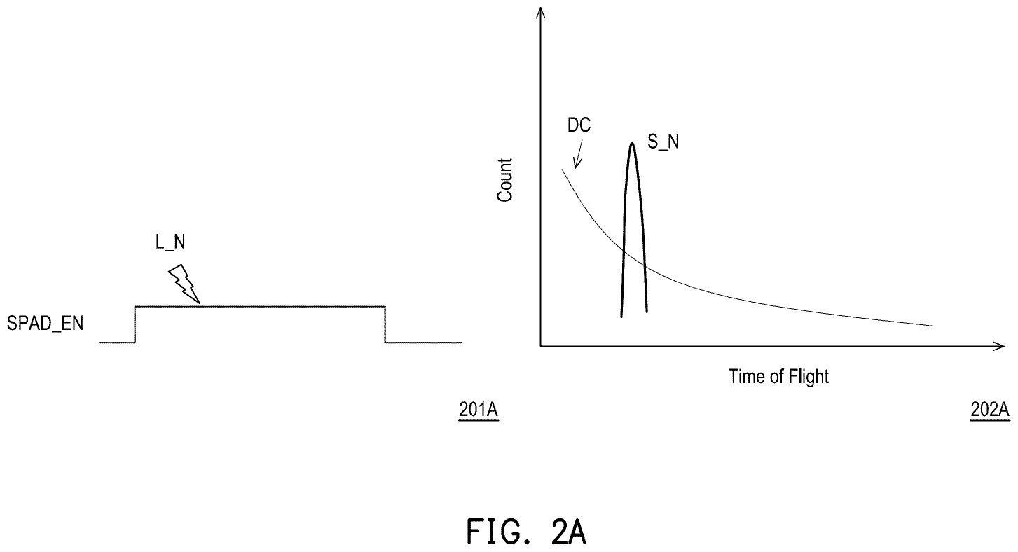

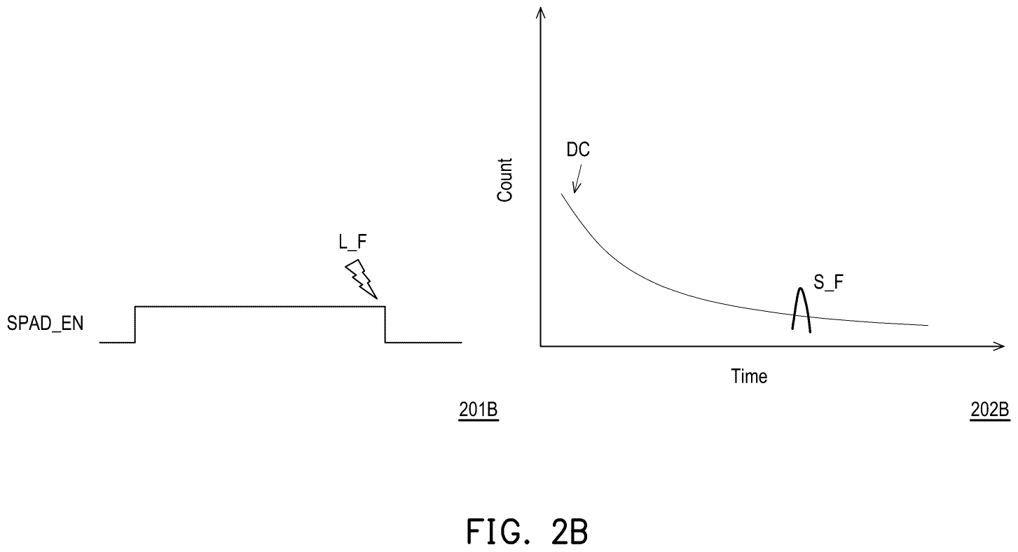

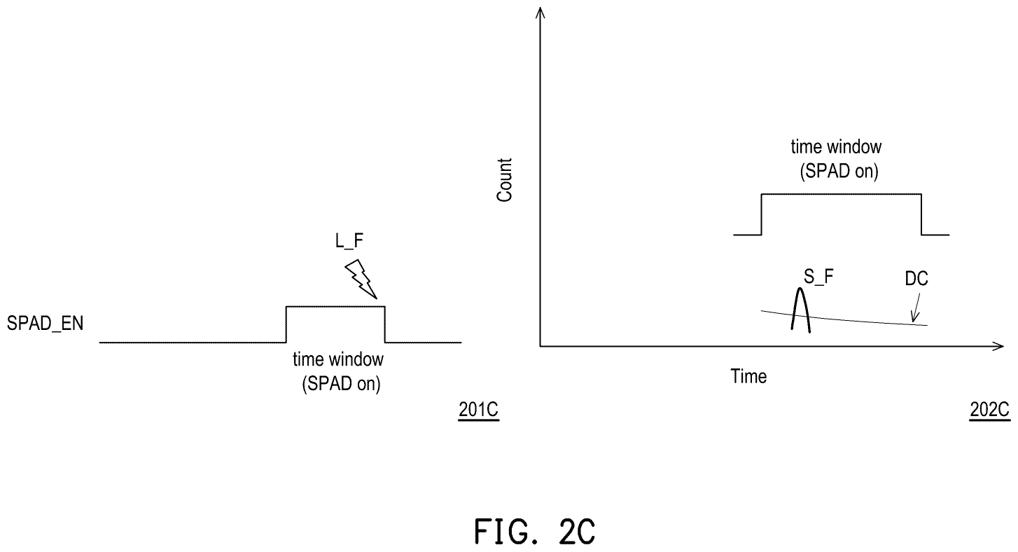

FIG. 2A, FIG. 2B, FIG. 2C are schematic diagrams of TOF detecting scenario according to some embodiments of the disclosure.

Reference is first made to FIG. 2A. In FIG. 2A, a TOF detecting scenario may include a signal condition 201A and a sampling result 202A. In this embodiment, the object OBJ may be the “near target”. That is, a distance between the object OBJ and the TOF detecting device 100 is less than a predetermined distance. In the signal condition 201A, a SPAD enable signal SPAD_EN is switched to a logic high for a period of time to turn on the SPAD sensor 110.

During the period of time, the SPAD sensor 110 may receive a reflected light L_N from the object OBJ. The output of the SPAD sensor 110 may be processed by the processing circuit 120 to generate the sampling result 202A. In the sampling result 202A, a dark count DC represents a background noise due to the characteristic of the SPAD sensor 110 and a sample signal S_N represents a processed result of the reflected light L_N. As shown in the sampling result 202A, because of SPAD nature, the dark count DC value for small time of flight range is higher than that for large time of flight. Further, as time passes, the dark count DC will gradually decrease and approach a non-zero value. In one embodiment, a theoretical value of the dark count DC may be represented by the following equation.

$${Ae}^{- t / τ} ,$$

wherein A is a parameter positively proportional to total sample counts and related to the characteristic of the SPAD sensor 110, t is the time since the pulse laser being emitted for the depth sensing, and t is a time constant of the dark counts DC.

It is noted that, since the object is the “near target”, the signal strength of the sampling signal S_N may be strong and the signal counts of the sampling signal S_N may be greater than the signal counts of the dark count DC. That is, it is easy to distinguish the sampling signal S_N from the dark count DC.

Reference is then made to FIG. 2B. In FIG. 2B, a TOF detecting scenario may include a signal condition 201B and a sampling result 202B. In this embodiment, the object OBJ may be the “far target”. That is, a distance between the object OBJ and the TOF detecting device 100 is not less than a predetermined distance. In the signal condition 201B, a SPAD enable signal SPAD_EN is switched to a logic high for a period of time to turn on the SPAD sensor 110.

During the period of time, the SPAD sensor 110 may receive a reflected light L_F from the object OBJ. The output of the SPAD sensor 110 may be processed by the processing circuit 120 to generate the sampling result 202B. In the sampling result 202B, a sample signal S_F represents a processed result of the reflected light L_F.

It is noted that, since the object is the “far target”, the signal strength of the sampling signal S_F may be not that strong and the signal counts of the sampling signal S_F may be similar as or even smaller than the signal counts of the dark count DC. That is, it may be difficult to distinguish the sampling signal S_F from the dark count DC.

Reference is now made to FIG. 2C. In FIG. 2C, a TOF detecting scenario may include a signal condition 201C and a sampling result 202C. In this embodiment, the object OBJ may be also the “far target”. That is, a distance between the object OBJ and the TOF detecting device 100 is not less than a predetermined distance. In the signal condition 201C, compared to the signal condition 201B, a SPAD enable signal SPAD_EN is switched to a logic high for a shorter period of time (i.e., a time window shown in FIG. 2C) to turn on the SPAD sensor 110.

During the shorter period of time, the SPAD sensor 110 may receive a reflected light L_F from the object OBJ. The output of the SPAD sensor 110 may be processed by the processing circuit 120 to generate the sampling result 202C. In the sampling result 202C, a sample signal S_F represents a processed result of the reflected light L_F.

In one embodiment, in the signal condition 201C, the object OBJ may be determined as the “far target”. In response to the object OBJ being determined as the “far target”, the SPAD enable signal SPAD_EN may be configured to disable the SPAD sensor 110 first. That is, since the object OBJ is not the “near target”, there won't be any signal received by the SPAD sensor 110 right after the pulsed laser is emitted. Then, after a predetermined time after the pulsed laser being emitted, the SPAD enable signal SPAD_EN may be configured to enable the SPAD sensor 110. That is, the SPAD sensor 110 is only enabled while it is expected that there is the reflected light L_F going to be received by the SPAD sensor 110. In other words, instead of the SPAD sensor 110 is turned ON in a longer period of time, the SPAD sensor 110 is turned ON in a shorter period of time. In this manner, the influence of the dark count DC may decrease since the SPAD sensor 110 is turned OFF at a beginning of the depth sensing. As a whole, the influence of the dark count DC to the sample signal S_F may also decrease and the accuracy of the depth sensing for a “far target” may increase.

It is noted that, in order to determine whether the object OBJ is the “near target” or the “far target” accurately, at a beginning of the depth sensing, the TOF detecting device 100 may be configured to emit a certain number of the incident lights L1. Correspondingly, a number of the reflected light L_N for the “near target” or a number of the reflected light L_F for the “far target” may be received. The number of the reflected light L_N may be substantially equal to the certain number and the number of the reflected light L_F may be smaller than the certain number.

In addition, signal counts of the sampling signal S_N for the “near target” may be greater than signal counts of the dark count DC and signal counts of the sampling signal S_F for the “far target” may be equal to or smaller than the signal counts of the dark count DC. That is, a relationship between the sampling signal S_N and the dark count DC and a relationship between the sampling signal S_F and the dark count DC may be used to determine the object OBJ is the “near target” or the “far target”. For example, a first sum of the signal counts of the sampling signal S_N and the signal counts of the dark count DC may be calculated. On the other hand, a second sum of the signal counts of the sampling signal S_F and the signal counts of the dark count DC may be calculated. The first sum or the second sum may be compared to the signal counts of the dark count DC. Specifically, if a sum (e.g., the first sum) of signal counts of a sampling signal (e.g., the sampling signal S_N) and signal counts of the dark count DC is greater than the signal counts of the dark count DC, the object OBJ may be determined as the “near target”. On the other hand, if a sum (e.g., the second sum) of signal counts of a sampling signal (e.g., the sampling signal S_F) and signal counts of the dark count DC is not significantly greater than the signal counts of the dark count DC, the object OBJ may be determined as the “far target”. In this manner, the TOF detecting device 100 is able to perform the depth sensing accurately no matter the object OBJ is close to or far from the TOF detecting device 100.

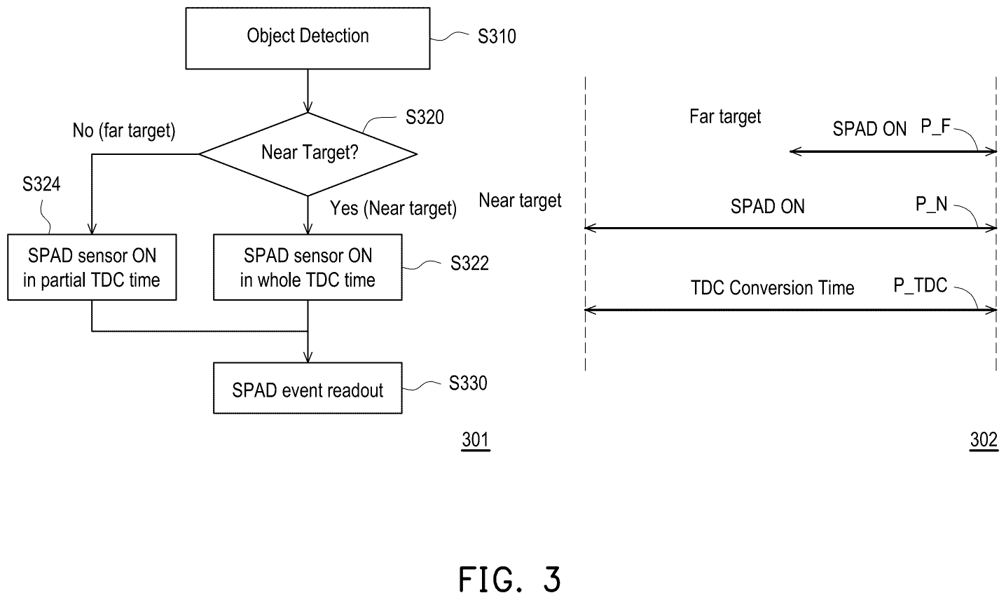

FIG. 3 is a schematic diagram of a TOF detecting configuration of a TOF detecting according to an embodiment of the disclosure. With reference to FIG. 3, the TOF detecting configuration includes a far target detection method 301 and a timing chart 302.

Reference is first made to the far target detection method 301. The far target detection method 301 includes a step S310, a step S320, a step S322, a step S324, and a step S330. In the step S310, the objection detection S310 is performed to detect the distance between the object OBJ and the TOF detecting device 100.

In the step S320, the TOF detecting device 100 may be configured to determine whether the object OBJ is a “near target” or a “far target”. For example, a predetermined distance may be used for the categorizing. That is, the distance between the object OBJ and the TOF detecting device 100 may be compared with predetermined distance. If the distance is less than the predetermined distance, then the object OBJ is determined as the “near target”. On the other hand, if the distance is not less than the predetermined distance, then the object OBJ is determined as the “far target”. In other words, the step S320 may be referred to as a “far target detection”.

In the step S322, in response to the object OBJ being determined as the “near target”, the SPAD sensor 110 may be configured to turn ON in whole time-to-digital conversion (TDC) time. The TDC time is a turn on time of a TDC circuit and the TDC circuit may be configured to convert the received light L2 to a time point. In the step S324, in response to the object OBJ being determined as the “far target”, the SPAD sensor 110 may be configured to turn ON in partial time-to-digital conversion (TDC) time. In the step S330, the TOF detecting device 100 may be configured to read out the signal generated by the TDC circuit. In other words, the step S322, the step S324, and the step S330 are configured to control the TOF detecting device 100 based on the result of the step S320. Therefore, these steps may be referred to as “control logic” of the TOF detecting device 100.

In one embodiment, for a depth sensing of the object OBJ, the TOF detecting device 100 may be configured to emit a number of the incident lights L1. The number of incident lights L1 may be referred to as a “total count” of the incident lights L1. The TOF detecting device 100 may be also configured to receive the total count of reflective lights L2. In order to perform the “far target detection”, the TOF detecting device 100 may be configured to emit a first count of the incident lights L1 out of the total count of the incident lights through the light source LS. That is, some of the incident lights may be emitted in an early stage (e.g., at the beginning) of the depth sensing to determine whether the object OBJ is the “near target” or the “far target”. Then, after the object OBJ has been determined as the “near target” or the “far target”, the TOF detecting device 100 may be configured to emit a second count of the incident lights L1 out of the total count of the incident lights. The total count may be a sum of the first count and the second count. That is, the TOF detecting device 100 may be configured to emit some of the total count of the incident lights L1 for the “far target detection” and then emit rest of the total count of the incident lights L1 for the depth sensing of the object OBJ utilizing the “control logic”. In other words, the depth sensing of the object OBJ may be performed in two stages, which is similar as the concept of a coarse tuning and a fine tuning. In this manner, an effective and energy-saving method to perform the depth sensing for an object OBJ far away from the TOF detecting device 100 may be achieved.

Reference is now made to the timing chart 302. The timing chart 302 is an exemplary embodiment the “control logic” of the TOF detecting device 100. The timing chart 302 includes a far period P_F, a near period P_N, and a TDC period P_TDC. The far period P_F represents a time period of the SPAD sensor 110 being enabled when the object OBJ is determined as the “far target”. The far period P_N represents a time period of the SPAD sensor 110 being enabled when the object OBJ is determined as the “near target”. The TDC period P_TDC represents a time period of a TDC circuit 110 being enabled for a depth sensing of the object OBJ.

As shown in the timing chart 302, the near period P_N may be equal to the TDC period P_TDC and the far period P_F may be shorter than the TDC period P_TDC. That is, the SPAD sensor 110 is only enabled while it is expected that there is the reflected light L_F going to be received by the SPAD sensor 110. In other words, instead of the SPAD sensor 110 is always turned ON during the depth sensing, the turning ON time of SPAD sensor 110 may be adjusted based on a type (i.e., “near target” or “far target” of the object OBJ). Therefore, the influence of the dark count DC to the sample signal S_F may also decrease, the energy consumption may decrease, and the accuracy of the depth sensing for a “far target” may increase.

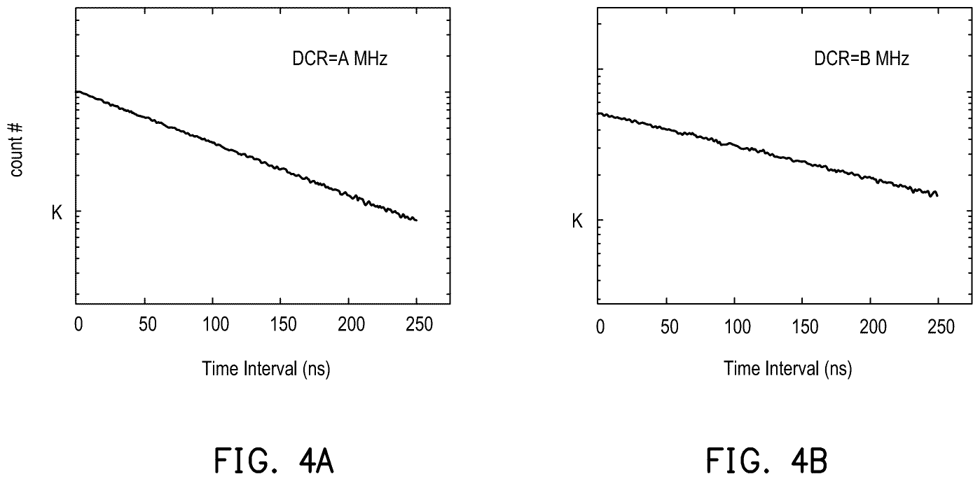

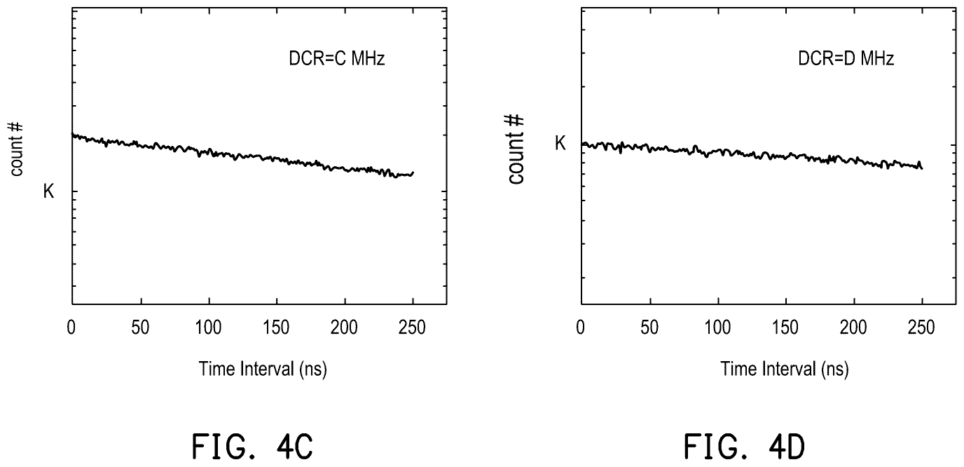

FIG. 4A to FIG. 4D is schematic diagrams of simulation results of dark count ratios of a TOF detecting according to some embodiment of the disclosure.

Signal-to-noise ratio (SNR) is a measure used in science and engineering that compares the level of a desired signal to the level of background noise. A high SNR indicates that the signal is strong and easy to distinguish from the noise, while a low SNR indicates that the signal is weak and difficult to distinguish from the noise.

In FIG. 4A to FIG. 4D, the dark counts ratio is obtained by dividing signal counts of the dark count DC by total simulation counts). As shown in FIG. 4A to FIG. 4D, as a dark count rate (DCR) (i.e., how often that one dark count DC occurs) decreases (A>B>C>D), the dark counts ratio also decreases. That is, the SNR increases. Therefore, by turning off the SPAD sensor 110 at the beginning of the depth sensing for the “far target”, the DCR may decrease and the SNR may increase. In this manner, an effective and energy-saving method to perform the depth sensing for an object OBJ far away from the TOF detecting device 100 is achieved.

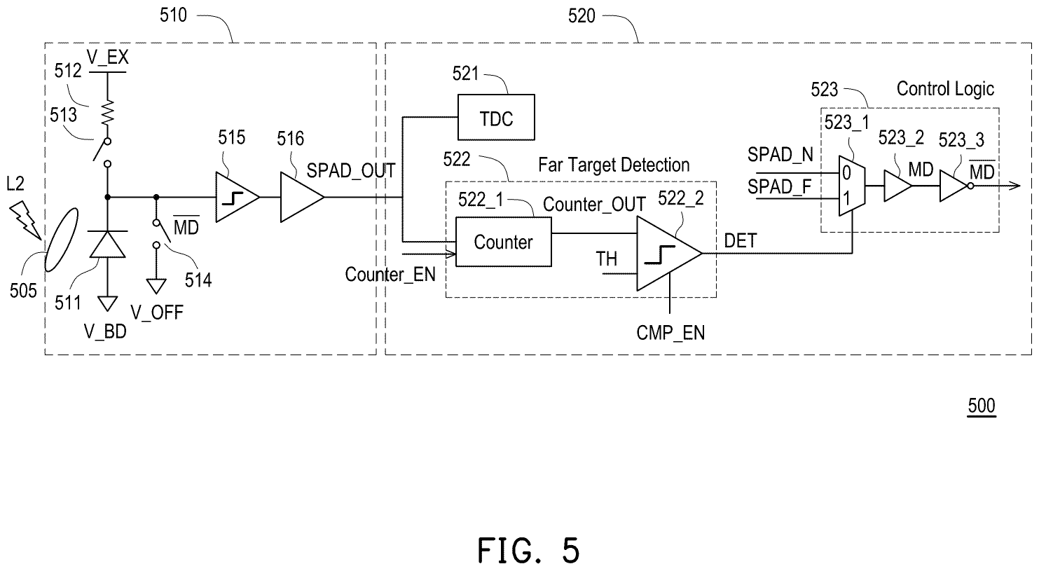

FIG. 5 is a schematic circuit structure of a TOF detecting device according to an embodiment of the disclosure. FIG. 5 is an exemplary circuit structure of the TOF detecting device 100, but this disclosure is not limited thereto.

With reference to FIG. 5, a TOF detecting device 500 may include a TOF sensing circuit 510 and a TOF processing circuit 520. The TOF sensing circuit 510 may correspond to the TOF sensor 110 and the TOF processing circuit 520 may correspond to the processing 120, but this disclosure is not limited thereto.

The TOF sensing circuit 510 may include a TOF sensor 511, a resistor 512, a switch 513 (also referred to as a first switch), a switch 514 (also referred to as a second switch), a comparator 515, and a buffer 516. A first end of the TOF sensor 511 is configured receive a bias voltage V_BD and a second end of the TOF sensor 511 is electrically coupled to a first end of the switch 513. A first end of the resistor 512 is electrically coupled a second end of the switch 513 and a second end of the resistor 512 is configured to receive an excess bias voltage V_EX. A first end of the switch 514 is configured to receive a shutdown voltage V_OFF and a second end of the switch 514 is also electrically coupled to the second end of the TOF sensor 511. An input end of the comparator 515 is electrically coupled to the second end of the TOF sensor 511, the first end of the switch 513, and the second end of the switch 514. An output end of the comparator 515 is electrically coupled to an input end of the buffer 516 and an output end of the buffer 516 is electrically coupled to an input terminal of the TOF processing circuit 520.

In addition, a band-pass filter 505 may be included in the TOF detecting device 500. The band-pass filter 505 may be integrated in the TOF sensing circuit 510 or disposed separately. The band-pass filter 505 may be configured to receive and filter the reflected light L2 and provide a filtered light to the TOF sensor 511.

In operation, the TOF sensor 511 is configured to receive the reflected light L2 or the filtered light. The switch 513 is configured to electrically couple the first end of the switch 513 and the second end of the switch 513 based on a mode signal MD. The switch 514 is configured to electrically couple the first end of the switch 514 and the second end of the switch 514 based on an inverted mode signal M̅D̅. The comparator 515 is configured to compare a SPAD output signal SPAD_OUT from the TOF sensor 511 with a predetermined value to determine whether to pass the output signal SPAD_OUT to the buffer 516 or not. The buffer 516 is configured to receive the SPAD output signal SPAD_OUT and provide the SPAD output signal SPAD_OUT to the TOF processing circuit 520.

The TOF processing circuit 520 may include a TDC circuit 521, a far target detection circuit 522, and a control logic circuit 523. The far target detection circuit 522 may include a counter 522_1 and a comparator 522_2. The control logic circuit 523 may include a multiplexer 523_1, a buffer 523_2, and an inverter 523_3. An input end of the TDC circuit 521 is configured to receive the SPAD output signal SPAD_OUT and an output end (not shown) of the TDC circuit 521 is configured to provide a TDC output signal (not shown) for further analysis. A first input end of the counter 522_1 is configured to receive the SPAD output signal SPAD_OUT, a second input end of the counter 522_1 is configured to receive a counter enable signal Counter_EN, and an output end is configured to provide a counter output signal Counter_OUT. A first input end of the comparator 522_2 is configured to receive the counter output signal Counter_OUT, a second input end of the comparator 522_2 is configured to receive a threshold signal TH, an enable end of the comparator 522_2 is configured to receive a comparator enable signal CMP_EN, and an output end of the comparator 522_2 is configured to provide a far target detection signal DET. A first input end of the multiplexer 523_1 is configured to receive a SPAD near signal SPAD_N and a second input end of the multiplexer 523_1 is configured to receive a SPAD far signal SPAD_F, an enable end of the multiplexer 523_1 is configured to receive the far target detection signal DET, and an output end of the multiplexer 523_1 is configured to provide one of the SPAD near signal SPAD_N and the SPAD far signal SPAD_F as the mode signal MD. An input end of the buffer 523_2 is configured to receive the mode signal MD and an output end of the buffer 523_2 is configured to provide the mode signal MD. An input end of the inverter 523_3 is configured to receive the mode signal MD and an output end of the inverter 523_3 is configured to provide the inverted mode signal M̅D̅.

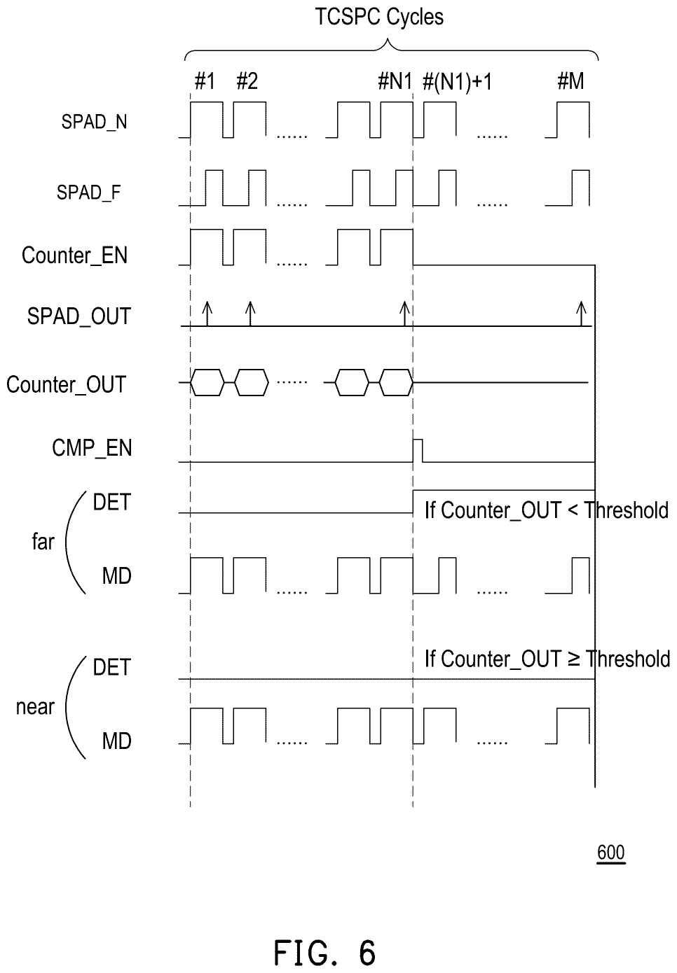

FIG. 6 is a schematic timing chart of a TOF detecting device according to an embodiment of the disclosure. In FIG. 6, a timing chart 600 is an exemplary timing chart of the TOF detection device 500, but this disclosure is not limited thereto.

In one embodiment, the TOF detection device 500 may be configured to perform a depth sensing of the object OBJ by two stages, the “far target detection” (i.e., the left half of timing chart 600) and the “control logic” (i.e., the right half of timing chart 600). In the “far target detection” stage, the light source LS may be configured to emit the incident light L1 for N1 cycles. Then, in the “control logic” stage, the light source LS may be configured to emit the incident light L1 for (M-N1) cycles. That is, the “total count” of the incident lights L1 may be M.

Specifically, the TOF detection device 500 may perform the far target detection utilizing the far target detection circuit 522 to generate the far target detection signal DET. Then, based on the far target detection signal DET, the control logic circuit 523 may be configured adjust a mode of the SPAD sensing circuit based on the mode signal MD. For example, when the counter output signal Counter_OUT is greater than or equal to the threshold signal TH, the object OBJ may be determined as the near target. On the other hand, when the counter output signal Counter_OUT is smaller than to the threshold signal TH, the object OBJ may be determined as the far target. In one embodiment, a value of the threshold signal TH may be determined based on characteristic of the SPAD sensor 110. That is, the value of the threshold signal TH may be equal to or slightly greater than a theoretical value of the dark count DC. However, this disclosure is not limited thereto.

In other words, when the object OBJ is determined as the near target, the far target detection signal DET remains at a logic low and the SPAD near signal SPAD_N may be determined as the mode signal MD. Therefore, in the “control logic” stage, for each cycle of the depth sensing, the SPAD sensor 511 may be turned ON in whole TDC time (i.e. the TDC period P_TDC) of the TDC circuit 521. On the other hand, when the object OBJ is determined as the far target, the far target detection signal DET switches to a logic high and the SPAD far signal SPAD_F may be determined as the mode signal MD. Therefore, in the “control logic” stage, for each cycle of the depth sensing, the SPAD sensor 511 may be turned ON in partial TDC time of the TDC circuit 521.

In this manner, the influence of the dark count DC may decrease since the SPAD sensor 511 is turned OFF at a beginning of the depth sensing. As a whole, the influence of the dark count DC to the sample signal S_F may also decrease and the accuracy of the depth sensing for a “far target” may increase.

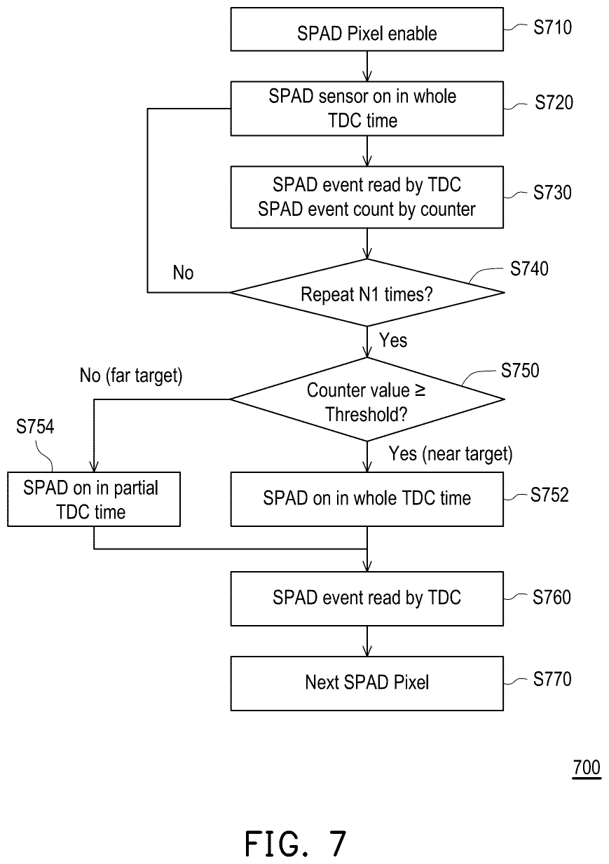

FIG. 7 is a schematic flowchart of a TOF detecting method according to an embodiment of the disclosure. In FIG. 7, a TOF detecting method 700 is an exemplary TOF detecting method of a SPAD pixel. The SPAD pixel may be included in a SPAD array and each of the SPAD pixel may be same as or similar as the TOF detection device 500. However, this disclosure is not limited thereto. The TOF detecting method 700 may include a step S710, a step S720, a step S730, a step S740, a step S750, a step S752, a step S754, a step S760, and a step S770.

In the step S710, the SPAD pixel may be enabled to perform a depth sensing. After the step S710, the “far target detection” stage may start and the SPAD pixel may be configured to determine that whether the object OBJ is the near target or the far target. Specifically, in the step S720, the SPAD sensor 511 may be turn ON in the whole TDC time. In the step S730, when the reflected light L2 is received by the SPAD sensor 511, one SPAD event may be counted. The SPAD event during the “far target detection” stage may be read by the TDC circuit 521 and counted by the counter 522_1. In the step S740, the counter 522_1 may be configured to determine that whether the SPAD sensor 511 has been turned ON for N1 times. If the SPAD sensor 511 has not been turned ON for N1 times, the step S720 will be performed again. If the SPAD sensor 511 has been turned ON for N1 times, the step S750 will be performed.

In the step S750, the comparator 522_2 may be configured to determine that whether the value of couther output signal during the N1 cycles is greater than the value of the threshold signal TH. If the value of couther output signal during the N1 cycles is greater than or greater than the value of the threshold signal TH, the object OBJ is determined as the near target and the step S752 will be performed. If the value of couther output signal during the N1 cycles is not greater than or equal to the value of the threshold signal TH, the object is determined as the far target and the step S754 will be performed.

After the step S750, the “control logic” stage will start. Specifically, the SPAD pixel may be configured to perform the depth sensing for (M-N1) times. In the step S752, for each cycle of the depth sensing, the SPAD sensor 511 may be turned ON in the whole TDC time of the TDC circuit 521. In the step S754, for each cycle of the depth sensing, the SPAD sensor 511 may be turned ON in partial TDC time of the TDC circuit 521. In the step S760, the SPAD event during the “control logic” stage may be read by the TDC circuit 521 until the (M-N1) times of depth sensing have been performed. In the step S770, the SPAD pixel may be disabled and a next SPAD pixel may be enabled to perform a flow similar as the TOF detecting method 700.

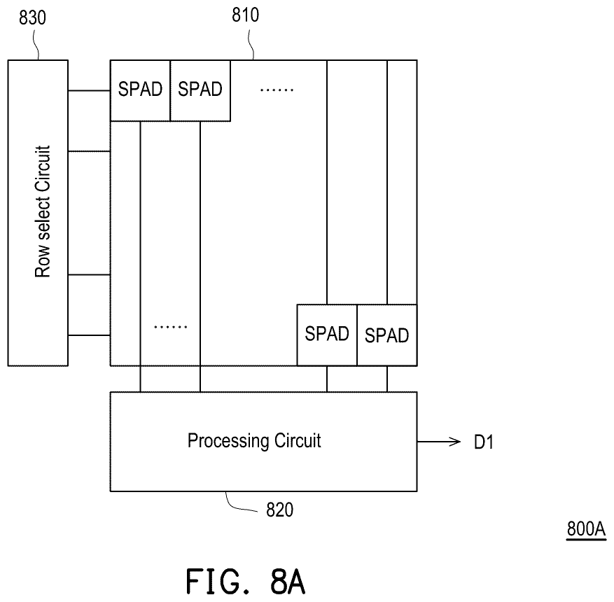

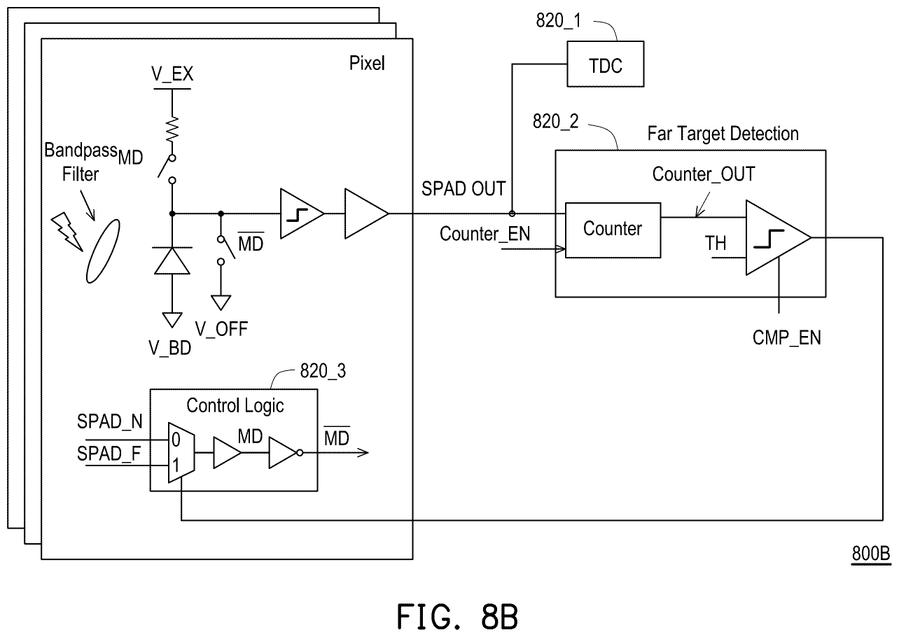

FIG. 8A and FIG. 8B are schematic circuit structures of a TOF detecting device to some embodiments of the disclosure. FIG. 8A and FIG. 8B are exemplary TOF detecting devices with an array of SPAD pixels. Each of the SPAD pixels may be same as or similar as the SPAD sensing circuit 510. However, this disclosure is not limited thereto.

Reference is first made to FIG. 8A. A TOF detecting device 800A may include a SPAD array 810, a processing circuit 820, and a row select circuit 830. The SPAD array 810 may include a plurality of SPAD pixels arranged in rows and columns. Each of the SPAD pixels may be same as or similar as the SPAD sensing circuit 510. However, this disclosure is not limited thereto. Each row of the SPAD array may be coupled to the row select circuit 830 and each column of the SPAD array may be coupled to the processing circuit 820. The processing circuit 820 may be same as or similar as the TDC circuit 520. However, this disclosure is not limited thereto.

In one embodiment, the row select circuit 112 may be configured to select a row of the SPAD pixels according to a row selection signal (not shown). The row selection signal may be generated by a clock circuit, a driver, a selection circuit or another suitable controlling device. Once the row of SPAD pixels are selected, the row of SPAD pixels may be enabled to receive the reflective light L2 from the optical system OS and column by column output the SPAD output signal SPAD_OUT to the processing circuit 820. The processing circuit 820 may be configured to detect a timing of the reflect light L2 and convert the original data from a time-based data into a distance-based data. It is noted that, while it is depicted for the sake of convenience in explanation that the SPAD array 810, the row select circuit 830, and the processing circuit 820 are depicted separately, the row select circuit 830, and the processing circuit 820 may be integrated in the SPAD array 810 or disposed outside the SPAD array 810. That is, this disclosure does not limit the SPAD array 810, the row select circuit 830, and the processing circuit 820 are integrated together or disposed separately.

Reference is first made to FIG. 8B. FIG. 8B is another exemplary circuit structure of the TOF detecting device 100, but this disclosure is not limited thereto.

With reference to FIG. 8B, a TOF detecting device 800B may include similar components as the TOF detecting device 500 and the TOF detecting device 800A. That is, the TOF detecting device 800B also includes the SPAD array 810 and the processing circuit 820. The difference is that, compared with the TOF detecting device 500, the control logic circuit 820_3 may be included in the SPAD pixel of the SPAD array 810, rather than the control logic circuit 523 is included in the processing circuit 820. That is, the processing circuit 820 may only include the TDC circuit 820_1 and the far target detection circuit 820_2. However, this disclosure is not limited thereto.

Based on the above, because the depth sensing of the object is performed in two stages, the distance of the object from the TOF detecting device is determined after the object is determined as the near target or the far target. In this manner, the depth sensing is able to be performed accurately no matter the object is close to or far from the TOF detecting device.

In one aspect of this disclosure, a time-of-flight (TOF) detecting device is provided. The TOF detecting device includes a single-photon avalanche diode (SPAD) sensing circuit and a processing circuit. The SPAD sensing circuit is configured to: receive a reflected light reflected from an object; and output a SPAD output signal based on the reflected light. The processing circuit is coupled to the SPAD sensor and configured to: determine that whether the object is a near target or a far target based on the SPAD output signal; in response to the object is the near target or the far target being determined, adjust a mode of the SPAD sensing circuit; and determine a distance between the object and the TOF detecting device based on the mode.

In a related embodiment, a distance between the near target and the TOF detecting device is less than a predetermined distance and a distance between the far target and the TOF detecting device is not less than a predetermined distance.

In a related embodiment, a dark count of a background noise is determined based on a characteristic of a SPAD sensor, and the processing circuit is further configured to: determine that whether the object is a near target or a far target based on the SPAD output signal and the dark count.

In a related embodiment, the processing circuit is further configured to: obtain a sum of signal counts of a sampling signal and signal counts of the dark count; in response to the sum is greater than the signal counts of the dark count, determine the object as the near object; and in response to the sum is not greater than the signal counts of the dark count, determine the object as the far object.

In a related embodiment, the TOF detecting device is configured to receive a total count of reflected lights from the object, and the processing circuit is further configured to: determine that whether the object is the near target or the far target based on a first count of the reflected lights out of the total count of the reflected lights; and determine a distance between the object and the TOF detecting device based on a second count of the reflected lights out of the total count of the reflected lights, wherein the total count is a sum of the first count and the second count.

In a related embodiment, the TOF sensing circuit is further configured to: in response to the object being determined as the near target, turn on a SPAD sensor in a whole time-to-digital conversion (TDC) time of a TDC circuit in the processing circuit.

In a related embodiment, the TOF sensing circuit is further configured to: in response to the object being determined as the near target, turn on a SPAD sensor in a partial time-to-digital conversion (TDC) time of a TDC circuit in the processing circuit.

In a related embodiment, the SPAD sensing circuit includes a SPAD sensor, a resistor, a first switch, a second switch, a comparator, and a buffer.

In a related embodiment, the processing circuit includes a time-to-digital conversion circuit, a far target detection circuit, and a control logic circuit.

In a related embodiment, the far target detection circuit includes a counter and a comparator.

In a related embodiment, the control logic circuit includes a multiplexer, a buffer, and an inverter.

In a related embodiment, the TOF detecting device further includes an infrared band-pass filter and the TOF sensing circuit includes a Germanium-Silicon SPAD sensor.

In another aspect of this disclosure, a time-of-flight (TOF) detecting system is provided. The time-of-flight (TOF) detecting system includes: a light source, configured to emit an incident light to an object; an optical system, configured to receive the reflected light after the incident light being reflected by the object and output the reflected light; a single-photon avalanche diode (SPAD) sensing circuit, configured to: receive a reflected light reflected from an object; and output a SPAD output signal based on the reflected light; and a processing circuit, coupled to the SPAD sensor and configured to: determine that whether the object is a near target or a far target based on the SPAD output signal; in response to the object is the near target or the far target being determined, adjust a mode of the SPAD sensing circuit; and determine a distance between the object and the TOF detecting device based on the mode.

In a related embodiment, a distance between the near target and the TOF detecting device is less than a predetermined distance and a distance between the far target and the TOF detecting device is not less than a predetermined distance.

In a related embodiment, a dark count of a background noise is determined based on a characteristic of a SPAD sensor, and the processing circuit is further configured to: determine that whether the object is a near target or a far target based on the SPAD output signal and the dark count.

In a related embodiment, the TOF sensing circuit is further configured to: in response to the object being determined as the near target, turn on a SPAD sensor in a whole time-to-digital conversion (TDC) time of a TDC circuit in the processing circuit.

In a related embodiment, the TOF sensing circuit is further configured to: in response to the object being determined as the near target, turn on a SPAD sensor in a partial time-to-digital conversion (TDC) time of a TDC circuit in the processing circuit.

In a related embodiment, the TOF detecting system further includes an infrared band-pass filter and the TOF sensing circuit includes a Germanium-Silicon SPAD sensor.

In yet another aspect of this disclosure, a time-of-flight (TOF) detecting method is provided. The time-of-flight (TOF) detecting method includes: receiving, by a single-photon avalanche diode (SPAD) sensing circuit, a reflected light reflected from an object; outputting, by the SPAD sensing circuit, a SPAD output signal based on the reflected light; determining, by the processing circuit, that whether the object is a near target or a far target based on the SPAD output signal; in response to the object is the near target or the far target being determined, adjusting, by the processing circuit, a mode of the SPAD sensing circuit; and determining, by the processing circuit, a distance between the object and the TOF detecting device based on the mode.

In a related embodiment, the TOF sensing circuit is configured to receive a total count of reflected lights from the object, and the TOF detecting method further comprises: determining that whether the object is the near target or the far target based on a first count of the reflected lights out of the total count of the reflected lights; and determining a distance between the object and the TOF detecting device based on a second count of the reflected lights out of the total count of the reflected lights, wherein the total count is a sum of the first count and the second count.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A time-of-flight (TOF) detecting device, comprising:
a single-photon avalanche diode (SPAD) sensing circuit, configured to:
receive a reflected light reflected from an object; and
output a SPAD output signal based on the reflected light; and
a processing circuit, coupled to the SPAD sensor and configured to:
determine that whether the object is a near target or a far target based on the SPAD output signal;
in response to the object is the near target or the far target being determined, adjust a mode of the SPAD sensing circuit; and
determine a distance between the object and the TOF detecting device based on the mode.

2. The TOF detecting device according to claim 1, wherein a distance between the near target and the TOF detecting device is less than a predetermined distance and a distance between the far target and the TOF detecting device is not less than a predetermined distance.

3. The TOF detecting device according to claim 1, wherein
a dark count of a background noise is determined based on a characteristic of a SPAD sensor, and
the processing circuit is further configured to:
determine that whether the object is a near target or a far target based on the SPAD output signal and the dark count.

4. The TOF detecting device according to claim 3, wherein
the processing circuit is further configured to:
obtain a sum of signal counts of a sampling signal and signal counts of the dark count;
in response to the sum is greater than the signal counts of the dark count, determine the object as the near object; and
in response to the sum is not greater than the signal counts of the dark count, determine the object as the far object.

5. The TOF detecting device according to claim 1, wherein
the TOF detecting device is configured to receive a total count of reflected lights from the object, and
the processing circuit is further configured to:
determine that whether the object is the near target or the far target based on a first count of the reflected lights out of the total count of the reflected lights; and
determine a distance between the object and the TOF detecting device based on a second count of the reflected lights out of the total count of the reflected lights, wherein the total count is a sum of the first count and the second count.

6. The TOF detecting device according to claim 1, wherein
the TOF sensing circuit is further configured to:
in response to the object being determined as the near target, turn on a SPAD sensor in a whole time-to-digital conversion (TDC) time of a TDC circuit in the processing circuit.

7. The TOF detecting device according to claim 1, wherein
the TOF sensing circuit is further configured to:
in response to the object being determined as the near target, turn on a SPAD sensor in a partial time-to-digital conversion (TDC) time of a TDC circuit in the processing circuit.

8. The TOF detecting device according to claim 1, wherein the SPAD sensing circuit comprises a SPAD sensor, a resistor, a first switch, a second switch, a comparator, and a buffer.

9. The TOF detecting device according to claim 1, wherein the processing circuit comprises a time-to-digital conversion circuit, a far target detection circuit, and a control logic circuit.

10. The TOF detecting device according to claim 9, wherein the far target detection circuit comprises a counter and a comparator.

11. The TOF detecting device according to claim 9, wherein the control logic circuit comprises a multiplexer, a buffer, and an inverter.

12. The TOF detecting device according to claim 1, further comprising an infrared band-pass filter and the TOF sensing circuit comprises a Germanium-Silicon SPAD sensor.

13. A time-of-flight (TOF) detecting system, comprising:
a light source, configured to emit an incident light to an object;
an optical system, configured to receive a reflected light after the incident light being reflected by the object and output the reflected light;
a single-photon avalanche diode (SPAD) sensing circuit, configured to:
receive the reflected light reflected from the object; and
output a SPAD output signal based on the reflected light; and
a processing circuit, coupled to the SPAD sensor and configured to:
determine that whether the object is a near target or a far target based on the SPAD output signal;
in response to the object is the near target or the far target being determined, adjust a mode of the SPAD sensing circuit; and
determine a distance between the object and the TOF detecting device based on the mode.

14. The TOF detecting system according to claim 13, wherein a distance between the near target and the TOF detecting device is less than a predetermined distance and a distance between the far target and the TOF detecting device is not less than a predetermined distance.

15. The TOF detecting system according to claim 13, wherein
a dark count of a background noise is determined based on a characteristic of a SPAD sensor, and
the processing circuit is further configured to:
determine that whether the object is a near target or a far target based on the SPAD output signal and the dark count.

16. The TOF detecting system according to claim 13, wherein
the TOF sensing circuit is further configured to:
in response to the object being determined as the near target, turn on a SPAD sensor in a whole time-to-digital conversion (TDC) time of a TDC circuit in the processing circuit.

17. The TOF detecting system according to claim 13, wherein
the TOF sensing circuit is further configured to:
in response to the object being determined as the near target, turn on a SPAD sensor in a partial time-to-digital conversion (TDC) time of a TDC circuit in the processing circuit.

18. The TOF detecting system according to claim 13, further comprising an infrared band-pass filter and the TOF sensing circuit comprises a Germanium-Silicon SPAD sensor.

19. A time-of-flight (TOF) detecting method, comprising:
receiving, by a single-photon avalanche diode (SPAD) sensing circuit, a reflected light reflected from an object;
outputting, by the SPAD sensing circuit, a SPAD output signal based on the reflected light;
determining, by the processing circuit, that whether the object is a near target or a far target based on the SPAD output signal;
in response to the object is the near target or the far target being determined, adjusting, by the processing circuit, a mode of the SPAD sensing circuit; and
determining, by the processing circuit, a distance between the object and the TOF detecting device based on the mode.

20. The TOF detecting method according to claim 19, wherein
the TOF sensing circuit is configured to receive a total count of reflected lights from the object, and
the TOF detecting method further comprises:
determining that whether the object is the near target or the far target based on a first count of the reflected lights out of the total count of the reflected lights; and
determining a distance between the object and the TOF detecting device based on a second count of the reflected lights out of the total count of the reflected lights, wherein the total count is a sum of the first count and the second count.
